(19) United States
(12) Patent Application Publication
(10) Pub. No.: US 2005/0215425 A1
(43) Pub. Date: Sep. 29, 2005

(54) Esterification catalyst and process therewith

(76) Inventors: Jerry Dale St. Clair, Wallingford, PA (US); Donald Edward Putzig, Newark, DE (US); Thomas W. Del Pesco, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/810,399

(22) Filed: Mar. 26, 2004

(51) Int. Cl. B01J 31/00; C07F 7/28

(52) U.S. Cl. 502/150; 502/152; 502/154; 502/155; 502/162; 556/51

(57) ABSTRACT

A process for producing polybutylene terephthalate comprises contacting terephthalic acid or its salt or its ester and butylenes glycol, in the presence of a catalyst composition, which comprises, or is produced from, titanium or a titanium compound, a complexing agent, a phosphorus-containing ester, and optionally a solvent. The process can also comprise contacting terephthalic acid or its salt or its ester and a glycol, in the presence of a catalyst composition to produce an oligomer and contacting the oligomer with a phosphorus-containing ester in which the catalyst composition can be one that catalyzes esterification or transesterification or polycondensation.

### FIELD OF INVENTION

This invention relates to a process for producing polyester with a catalyst composition comprising titanium and color stabilizer.

### BACKGROUND OF INVENTION

Polyesters such as, for example, polyethylene terephthalate, polytrimethylene terephthalate and polybutylene terephthalate (PBT), are a class of important industrial polymers. They are widely used in thermoplastic fibers, films, and molding applications.

Polyesters can be produced by transesterification of an ester such as dimethyl terephthalate (DMT) with a glycol followed by polycondensation or by direct esterification of an acid such as terephthalic acid (TPA) with a glycol followed by polycondensation. A catalyst is used to catalyze the esterification, transesterification and/or polycondensation. For example, polyester can be produced by injecting a slurry mixture of TPA and glycol at about 80° C. into an esterifier. Linear oligomer with degree of polymerization less than 10 are formed in one or two esterifiers at temperatures from 240° C. to 290° C. The oligomer is then polymerized in one or two prepolymerizers and then a final polymerizer or finisher at temperatures from 250° C. to 300° C. TPA esterification is catalyzed by the carboxyl groups of the acid.

Antimony is often used as a catalyst for the polymerization or polycondensation reaction. However, antimony-based catalysts are also coming under increased environmental pressure and regulatory control, especially in food contact applications. Tin compounds can also be used in the esterification, transesterification, and polycondensation reactions. However, tin-based catalysts have similar toxicity and regulatory concerns.

Titanium catalysts can be used in the esterification, transesterification, and polycondensation reactions. However, the titanium catalysts tend to hydrolyze on contact with water forming glycol-insoluble oligomeric species, which lose catalytic activity. Esters and polyesters produced from an organic titanate may also suffer from yellow discoloration. Further, when organic titanates are used as catalysts for esterification or polyesterification of carbonyl compounds with 1,4-butanediol (BDO) such as during production of PBT, increased generation of tetrahydrofuran (THF) byproduct may occur. This increases the BDO consumption and cost of the esterification or polyesterification process.

The hydrolytic deactivation of titanium catalysts may be avoided by the use of water compatible titanates, such as titanium bis-ammonium lactate, bis-triethanolamine titanate or the titanium sodium citrate catalysts disclosed in EP 812818. However, when used as polyesterification catalysts, these titanium catalysts still suffer from significant yellow or tan discoloration in the resultant polymer. They may also require higher reaction temperatures, and may lead to excessive THF generation in esterification, transesterification, or polycondensation reactions involving BDO.

Therefore, there is an increasing need for developing a process that produces a polymer with lower THF formation, reduced color and is environmentally friendly.

### SUMMARY OF THE INVENTION

A composition comprises, or is produced from, titanium or a titanium compound, a complexing agent, a stabilizer, and optionally a solvent in which the stabilizer comprises a phosphorus-containing ester, a zirconium compound, or both.

A process, which can be used for, for example, producing an ester or polyester is provided. The process comprises contacting, in the presence of a catalyst composition, a carbonyl compound with an alcohol. The catalyst composition can be the same as that disclosed above.

### DETAILED DESCRIPTION OF THE INVENTION

The catalyst composition is preferably substantially soluble in a solvent. The term “substantially” means more than trivial. It is preferred that the composition be completely soluble in the solvent. However, a substantial portion of the composition can also be suspended or dispersed in the solvent. The composition can also be a stable solution in a solvent such as, for example, water, an alcohol, or both. The term “stable solution” means a solution that remains solution without has little or no substantial precipitation or suspension or dispersion of a solute at room temperature (about 25° C.) for at least about 1 day, or 5 days, 10 days, 20 days, or even 30 days.

The composition can comprise, consist essentially of, consist of, or be produced from, titanium or a titanium compound, a complexing agent, a color stabilizer comprising either a phosphorus-containing ester or a zirconium compound or both, and, optionally, a solvent. The composition can also comprise, consist essentially of, or consist of, a titanium chelate, a color stabilizer, and optionally a solvent. The titanium chelate can comprise, or be produced from, tetraalkyl titanate and a complexing agent and the color stabilizer can comprise a phosphorus-containing ester, a zirconium compound, or both.

The titanium compound can be an organic titanium compound. An example of titanium compound is tetraalkyl titanate, also referred to as titanium tetrahydrocarbyloxides. Examples of tetraalkyl titanates include those having the general formula Ti(OR)₄ where each R is individually selected from an alkyl, cycloalkyl, alkaryl, hydrocarbyl radical containing from 1 to about 30, preferably 2 to about 18, and most preferably 2 to 12 carbon atoms per radical and each R can be the same or different. Tetraalkyl titanates in which the hydrocarboxyl group contains from 2 to about 12 carbon atoms per radical which is a linear or branched alkyl radical are relatively inexpensive, readily available, and effective in forming a solution. Suitable tetraalkyl titanates include, but are not limited to, titanium tetraethoxide, titanium tetrapropoxide, titanium tetraisopropoxide, titanium tetra-n-butoxide, titanium tetrahexoxide, titanium tetra 2-ethylhexoxide, titanium tetraoctoxide, and combinations of two or more thereof.

A tetraalkyl titanate can also be combined with a zirconium compound to produce a mixture comprising a tetraalkyl titanate and a zirconium tetrahydrocarbyloxide. Examples of zirconium compounds include, but are not limited to, zirconium tetraethoxide, zirconium tetrapropoxide, zirconium tetraisopropoxide, zirconium tetra-n-butoxide, zirconium tetrahexoxide, zirconium tetra 2-ethylhexoxide, zirconium tetraoctoxide, and combinations of two or more thereof. The molar ratio of Ti/Zr can be in the range of from about 0.001:1 to about 10:1.

Suitable tetraalkyl titanates can be produced by, for example, mixing titanium tetrachloride and an alcohol in the presence of a base, such as ammonia, to form a tetraalkyl titanate. The alcohol can be ethanol, n-propanol, isopropanol, n-butanol, or isobutanol. Tetraalkyl titanates thus produced can be recovered by removing by-product ammonium chloride by any means known to one skilled in the art such as filtration followed by distilling the tetraalkyl titanates from the reaction mixture. This process can be carried out at a temperature in the range of from about 0 to about 150° C. Titanates having longer alkyl groups can also be produced by transesterification of those having R groups up to C₄ with alcohols having more than 4 carbon atoms per molecule.

Examples of commercially available organic titanium compounds include, but are not limited to, TYZOR® TPT and TYZOR® TBT (tetra isopropyl titanate and tetra n-butyl titanate, respectively) available from E. I. du Pont de Nemours and Company, Wilmington, Del., USA (DuPont).

Suitable complexing agents can be one or more alkanolamines. For example, a complexing agent can be an alkanolamine with one or more hydroxyalkyl groups. Examples of suitable complexing agents include, but are not limited to, ethanolamine, diethanolamine, triethanolamine, methyl, diethanolamine, dimethyl, ethanolamine, tri-isoproanolamine, and combinations of two or more thereof.

A titanium chelate can comprise or be produced from a tetraalkyl titanate and a complexing agent. Titanium chelate can be produced by any methods known to one skilled in the art or is commercially available. Example of commercially available titanium chelate include those available from DuPont such as, for example, TYZOR®LA (titanium bis-ammonium lactate), TYZOR®AA (bis-acetylacetonate titanate), TYZOR®DC (bis-ethyl acetoacetate titanate), TYZOR®TE (bis-triethanolamine titanate), or combinations of two or more thereof.

Stabilizer can comprise a phosphorus-containing ester, a zirconium compound, or a combination of two or more thereof.

Phosphorus-containing ester refers to an ester containing phosphorus in the molecule and includes, but is not limited to, a phosphite ester containing no free P—OH groups. Such esters include a tris-phosphite ester or diphosphonite ester. Specific examples of phosphorous-containing esters include, but are not limited to, tris-alkyl and aryl phosphites or aryl diphosphonite esters such as trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-,tetrakis(2,4-bis(1,1-dimethylethyl)phenyl)ester; (tris-(2,4-di-t-butyl)phosphite; tri-(ethlyene glycol)phosphite; tri-(propylene glycol)phosphite; tri-(butylene glycol)phosphite; or combinations of two or more thereof. A phosphorus-containing ester can also be introduced to other components of the composition during polycondensation stage. That is, it can be combined with other components and an oligomer as disclosed below.

The zirconium compound useful as stabilizer can be an organic zirconium compound Zr(OR)₄, or a zirconium chelate comprising or produced from Zr(OR)₄ and a complexing agent, or both where each R is the same as that disclosed above. Zirconium compound Zr(OR)₄ and complexing agents include those disclosed above. Examples of zirconium compound include those commercially available from DuPont such as, for example, tetrapropyl zirconate (TYZOR® NPZ), tetrabutyl zirconate in butanol (TYZOR® NBZ), tetrakis(triethanolamino) zirconate (TYZOR® TEAZ), or combinations of two or more thereof.

Examples of solvent is water or an alcohol having the formula of R¹ (OH)ₙ, an alkylene glycol of the formula (HO)ₙA(OH)ₙ, a polyalkylene glycol or alkoxylated alcohol having the formula of R¹O[CH₂CH(R¹)O]ₙH, or combinations of two or more thereof in which each R¹ can be the same or different and is a hydrocarbyl radical having 1 to about 10 carbon atoms per radical; R¹ can be an alkyl radical; A can be an alkylene radical having 2 to about 10 carbon atoms per molecule; and each n can be the same or different and is independently a number in the range of from 1 about to about 10. Examples of solvents include, but are not limited to, water, ethanol, propanol, isopropanol, butanol, ethylene glycol, propylene glycol, isopropylene glycol, butylene glycol, 1-methyl propylene glycol, pentylene glycol, diethylene glycol, triethylene glycol, 2-ethyl hexanol, and combinations of two or more thereof.

Alternatively, the solvent can be that which is formed on reaction of the tetraalkyltitanate with the complexing agent such as, for example, isopropyl alcohol from tetraisopropyltitanate or n-butyl alcohol from tetra n-butyltitanate.

The molar ratio of the complexing agent to titanium compound can be any effective ratio that can substantially prevent the precipitation of the titanium compound in the presence of a solvent. Generally, the ratio can be in the range of from about 1:1 to about 10:1, or about 1:1 to about 7:1, or 1:1 to 4:1. The molar ratio of color stabilizer to titanium compound (P:Ti or Zr:Ti) can be any ratio that, when the composition is used as catalyst to produce a polyester, can reduce the yellowness of the polyester such as, for example, in the range of from about 0.05:1 to about 50:1, or about 0.5:1 to about 20:1, or 1:1 to 10:1.

The composition can further comprise a co-catalyst such as tin, aluminum, cobalt, zirconium (as disclosed above), zinc, or a compound comprising one or more of these metals, and combinations of two or more thereof. For example, butyl stannoic acid, zinc acetate, zinc chloride, zinc nitrate, zinc sulfate, aluminum chloride, aluminum hydroxide, aluminum acetate, aluminum hydroxychloride, cobaltous acetate tetrahydrate, cobaltous nitrate, cobaltous chloride, cobalt acetylacetonate, cobalt napthenate, cobalt hydroxide, cobalt salicyl salicylate, and combinations of two or more thereof can be used as co-catalyst.

The catalyst composition can be produced by any means known to one skilled in the art such as, for example, mixing the individual components together. The catalyst composition can also be produced, in addition to or instead of, water, in a second solvent that is compatible with or does not interfere with an esterification or transesterification or polycondensation reaction. For example, if the catalyst composition is used as a polycondensation catalyst for producing polyethylene terephthalate, the composition can be produced in ethylene glycol; if the catalyst composition is used for producing polybutylene terephthalate, the composition can be produced in 1,4-butanediol; and if the catalyst composition is used for producing polypropylene terephthalate, the composition can be produced in 1,3-propylene glycol.

For example, a complexing agent, a color stabilizer, and a titanium compound are first combined, optionally in a solvent, to produce a mixture followed by optionally introducing a co-catalyst. The combining can be carried out under an inert atmosphere, such as nitrogen, carbon dioxide, helium, or combinations of two or more thereof. Producing the mixture can be stirred and can be carried out at a temperature in the range of from about 0° C. to about 100° C.

Generally any amount of solvent can be used as long as the amount can substantially dissolve the composition and can be in the range of from about 1 to about 50, or about 1 to about 20, or 1 to 10 moles per mole of the titanium compound used in the composition.

The quantities of individual components generally can be such that the molar ratio of each component to titanium in the catalyst composition produced is within the range disclosed above.

A process that can be used in, for example, the production of an ester or polyester is provided. The process comprises contacting, in the presence of a catalyst composition, a carbonyl compound with an alcohol. The composition can be the same as that disclosed above in the first embodiment of the present invention.

Any carbonyl compound, which when combined with an alcohol, can produce an ester or polyester can be used. Generally, such carbonyl compounds include, but are not limited to, acids, esters, amides, acid anhydrides, acid halides, salts of carboxylic acid oligomers or polymers having repeat units derived from an acid, or combinations of two or more thereof. Example of acid is an organic acid such as a carboxylic acid or salt or ester thereof.

A process for producing an ester or polyester can comprise, consist essentially of, or consist of contacting a reaction medium with a composition disclosed above. The reaction medium can comprise, consist essentially of, or consist of an alcohol and either (1) an organic acid, a salt thereof, an ester thereof, or combinations thereof or (2) an oligomer having repeat units derived from an organic acid or ester.

The organic acid or ester thereof can have the formula of R²COOR² in which each R² independently can be (1) hydrogen, (2) hydrocarboxyl radical having a carboxylic acid group at the terminus, or (3) hydrocarbyl radical in which each radical has 1 to about 30, carbon atoms per radical which can be alkyl, alkenyl, aryl, alkaryl, aralkyl radical, or combinations of two or more thereof, or (4) combinations of two or more thereof. For example, an organic acid can have the formula of HO₂CA¹CO₂H in which A¹ is an alkylene group, an arylene group, alkenylene group, or combinations of two or more thereof. Each A¹ has about 2 to about 30, or about 3 to about 25, or about 4 to about 20, or 4 to 15 carbon atoms per group. Examples of suitable organic acids include, but are not limited to, terephthalic acid, isophthalic acid, napthalic acid, succinic acid, adipic acid, phthalic acid, glutaric acid, acrylic acid, oxalic acid, benzoic acid, maleic acid, propenoic acid, and combinations of two or more thereof. Examples of suitable esters include, but are not limited to, dimethyl adipate, dimethyl phthalate, dimethyl terephthalate, methyl benzoate, dimethyl glutarate, and combinations of two or more thereof.

Examples of carboxylic acid metal salts or esters thereof includes a 5-sulfo isophthalate metal salt and its ester having the formula of (R³O₂C)₂ArS(O)₂OM¹ in which each R³ can be the same or different and is hydrogen or an alkyl group containing 1 to about 6, or 2, carbon atoms. Ar is a phenylene group. M¹ can be an alkali metal ion such as sodium. An example of the ester is bis-glycolate ester of 5-sulfo isophthalate sodium salt.

Any alcohol that can esterify an acid to produce an ester or polyester can be used in the present invention. Examples of suitable alcohols include, but are not limited to, ethanol, propanol, isopropanol, butanol, ethylene glycol, propylene glycol, isopropylene glycol, butylene glycol, 1-methyl propylene glycol, pentylene glycol, diethylene glycol, triethylene glycol, 2-ethyl hexanol, and combinations of two or more thereof.

When the carbonyl compound includes a 5-sulfo isophthalate metal salt or its ester as disclosed above, the alcohol can be ethylene glycol, propylene glycol, isopropylene glycol, butylene glycol, 1-methyl propylene glycol, pentylene glycol, diethylene glycol, triethylene glycol, 1,6-hexanediol, cyclohexyl-1,4-bismethanol, and combinations of two or more thereof. The contacting of a 5-sulfo-isophthalate metal salt or its ester and a glycol produces a bis-glycolate ester of 5-sulfo isophthalate metal salt.

The contacting of the carbonyl compound and alcohol can be carried out by any suitable means. For example, the carbonyl compound and alcohol can be combined before being contacted with the catalyst. For example, the catalyst can be dispersed in an alcohol by any suitable means such as mechanical mixing or stirring to produce a dispersion followed by combining the dispersion with (1) a carbonyl compound and (2) an alcohol under a condition sufficient to effect the production of a ester or polyester.

An oligomer can have a total of about 1 to about 100, or about 2 to about 10 repeat units derived from a carbonyl compound and alcohol.

Any suitable condition to effect the production of an ester or polyester can include a temperature in the range of from about 150° C. to about 500° C., preferably about 200° C. to about 400° C., and most preferably 250° C. to 300° C. under a pressure in the range of from about 0.001 to about 1 atmosphere for a time period of from about 0.2 to about 20, preferably about 0.3 to about 15, and most preferably 0.5 to 10 hours.

The molar ratio of the alcohol to carbonyl compound can be any ratio so long as the ratio can effect the production of an ester or polyester. Generally the ratio can be in the range of from about 1:1 to about 10:1, or about 1:1 to about 5:1, or 1:1 to 4:1.

The catalyst, expressed as Ti, can be present in the range of about 0.0001 to about 50,000, or about 0.001 to about 10,000, or 0.001 to 1000 ppmw, parts per million by weight (ppmw) of the medium comprising carbonyl compound and alcohol. The co-catalyst disclosed above, if used, can also be present in the same range (expressed as Sn, Zr, Zn, Al, or Co). Other ingredients such as conventional esterification and transesterification catalysts (e.g., manganese) and those enhancing catalyst stability or performance may be introduced to the production process concurrent with, or following, introduction of the composition disclosed herein.

The process can also be carried out by introducing a catalyst composition without the phosphorus-containing ester during easterification or transesterification during which an oligomer is produced. The phosphorus-containing ester component can be introduced to the oligomer for controlling the color or to prevent discoloration, of the final product. The phosphorus-containing ester introduced is at the same ratio to the titanium compound disclosed above.

The catalyst composition can be used in producing esters or polyesters by using any of the conventional melt or solid-state techniques. The catalyst compositions also can be used in promoting esterification, transesterification, polycondensation, or combinations thereof.

Also disclosed is a process that can be used to reduce the formation of color of polyester. The process can comprise contacting a carbonyl compound, optionally in the presence of a catalyst, with an alcohol to produce an oligomer and contacting the oligomer with a phosphorus-containing ester. The carbonyl compound, alcohol, oligomer, and phosphorus-containing ester can be the same as those disclose above. Any catalysts known to catalyze esterification or transesterification or polycondensation can be used in the process. Examples of such catalyst include antimony, manganese, cobalt, titanium, zirconium, tin, zinc, aluminum or combinations thereof. Generally, a phosphorus-containing ester can be introduced to a polyester process after an oligomer is produced such as during the polycondensation stage. Because the process for the production of oligomer and polyester are well known to one skilled in the art, the description of these is omitted herein for the interest of brevity.

The following Examples are provided to further illustrate the present invention and are not to be construed as to unduly limit the scope of the invention. All TYZOR® products were obtained from DuPont disclosed above.

### EXAMPLES

Commercial samples used were tetrabutyl titanate (TYZOR® TnBT), tetraisopropyl titanate (TYZOR® TPT), bis(triethanolamino) titanate in isopropanol (TYZOR® TE), tetrapropyl zirconate (TYZOR® NPZ), tetrabutyl zirconate in butanol (TYZOR® NBZ), and tetrakis(triethanolamino)zirconate (TYZOR® TEAZ). Other additive compositions were prepared as follows.

### Examples 1-5

Additive compositions were prepared by mixing either 1,4-butanediol (BDO) or TYZOR® TE with a phosphorus compound as specified in Table 1. Each mixture was blended for 10-15 minutes at room temperature.

TABLE 1

| | | Compo- | | P |
|---|---|---|---|---|
| Additive | Base | nent | Phosphorus | Compound |
| Designation | Component | Mass, g | Compound | Mass, g |
| TBP in | BDO | 247.5 | tributyl phosphate | 2.5 |
| BDO | | | | |
| TE-TBP 6 | TYZOR ® | 100.0 | tributyl phosphate | 6.7 |
| | TE | | | |
| TE-TBP-13 | TYZOR ® | 50.0 | tributyl phosphate | 6.7 |
| | TE | | | |
| TE-TEP | TYZOR ® | 50.0 | triethyl phosphate | 2.2 |
| | TE | | | |
| TE-TIP | TYZOR ® | 50.0 | triisopropyl | 2.8 |
| | TE | | phosphate | |

General Esterification Reaction Procedure

The reaction apparatus consisted of a 500 ml baffled resin kettle equipped with mechanical stirrer (stainless steel stirrer shaft and blade), heating mantle, thermometer, temperature controller, and still head with water-cooled condenser, post-condenser nitrogen inlet, and 100 ml receiver.

In a typical run, the apparatus was charged with 175 g (1.05 g-mol) terephthalic acid, 126.7 g (1.41 g-mol) 1,4-butanediol, and sufficient additive(s) to achieve the target concentration of catalyst, complexing agent, and color stabilizer. The apparatus was then purged with nitrogen and an inert nitrogen blanket was established.

Agitation and cooling water were started, and the temperature controller was set to 220° C. As soon as distillate began coming overhead (typically at 185-195° C.), a 3-hour hold was started. Distillation continued during the hold as the reaction temperature gradually rose to 220° C. The reaction mass was then allowed to cool and the distillate was weighed and sampled.

The reaction mass was analyzed for free carboxyl ends using conventional sodium hydroxide titration (H. A. Pohl, Analytical Chemistry (1954), 26 (10), 1614-1616). A relative color scale was established by visually separating all products into 5 groups ranging from white (1) to moderately discolored (5). The distillate was analyzed for weight percent THF by gas chromatography, and the total THF byproduct weight was calculated by multiplying the weight of distillate by the weight percent THF in the distillate.

### Examples 6-20

The General Esterification Reaction Procedure was performed for the additives and loadings shown in Table 2. The product properties and THF byproduct weight are also shown in Table 2.

TABLE 2

| | | | | | | | THF |
|---|---|---|---|---|---|---|---|
| | | Additive | | [stabilizer], | | Color | Yield, |
| Run | Additive/Catalyst¹ | Mass, g | [M], ppm² | ppm³ | COOH⁴ | Index⁶ | g⁵ |
| 1 | MBTO in BDO¹ | 21.9 | 2326 | — | 131 | 2 | 4 |
| 2 | TYZOR ® TnBT | 1.9 | 559 | — | 610 | 2 | 15 |
| 3 | TYZOR ® TPT | 1.4 | 907 | — | 495 | 1 | 15 |
| 4 | TYZOR ® NBZ | 2.7 | 2501 | — | 600 | 1 | 52 |
| 5 | TYZOR ® TE | 3.4 | 934 | — | 187 | 5 | 3 |
| 6 | TYZOR ® TE | 3.5 | 934 | — | 278 | 4 | 5 |
| | (repeat) | | | | | | |
| 7 | TYZOR ® TE | 3.5 | 934 | | 240 | 2 | 8 |
| | TBP in BDO | 24.7 | | 100 | | | |
| 8 | TE-TBP-6 | 3.7 | 934 | 94 | 252 | 1 | 7 |
| 9 | TE-TBP-13 | 3.9 | 934 | 189 | 371 | 1 | 8 |
| 10 | TE-TEP | 3.9 | 1000 | 102 | 358 | 3 | 6 |
| 11 | TE-TIP | 3.9 | 1000 | 102 | 352 | 3 | 6 |
| 12 | TYZOR ® TE | 3.5 | 939 | | 258 | 5 | 6 |
| | TYZOR ® NPZ | 0.7 | | 459 | | | |
| 13 | TYZOR ® TE | 3.5 | 938 | | 249 | 2 | 5 |
| | TYZOR ® TEAZ | 1.0 | | 436 | | | |
| 14 | TYZOR ® TE | 3.4 | 912 | | 172 | 3 | 6 |
| | TYZOR ® TEAZ | 0.85 | | 371 | | | |
| 15 | TYZOR ® TE | 3.5 | 940 | | 349 | 3 | 7 |
| | TYZOR ® TEAZ | 0.25 | | 109 | | | |

¹MBTO in BDO represents monobutyl tin oxide (also known as butyl stannoic acid) in 1,4-butanediol prepared according to the EXAMPLES of U.S. Pat. No. 5,891,985; see Examples 1-6 for the composition of the other additives.
²[M] represents the concentration of catalyst as metal (Sn or Ti) in solution in parts per million.
³[stabilizer] represents the concentration of color stabilizer as core element (P or Zr) in parts per million.
⁴COOH represents the analyzed unreacted free carboxyl ends in the product in meq/kg.
⁵Color Index represents the relative discoloration of the product from white (1) to moderately discolored (5) by visual comparison.
⁶THF Yield represents the grams tetrahydrofuran in the recovered distillate.

For comparison, Run 1 utilized a tin-based catalyst, which showed good catalytic activity (low COOH ends, low THF yield) and low product discoloration. Non-chelated titanates and zirconates (Runs 2-4) had much poorer catalytic activity as seen in high COOH ends and high THF production. Use of a chelated titanate (Runs 5-6) resulted in good catalytic activity but much higher color generation. The combination of chelated titanate with phosphite color stabilizer afforded product with lower color while maintaining good catalytic activity, whether the 2 additives were added separately (Run 7) or in pre-mixed combination (Runs 8-11). The combination of tetraalkyl zirconate with chelated titanate (Run 12) still had high discoloration, but when chelated zirconate was employed (Runs 13-15), both the catalytic and color performance was good.

1. A composition comprising, or produced from, a stabilizer, optionally a solvent and either (1) titanium or a titanium compound and a complexing agent or (2) a titanium chelate; said complexing agent is an alkanolamine; said complexing agent optionally contains one or more hydroxyalkyl groups; and said stabilizer comprises a phosphorus-containing ester containing no free P—OH group, a zirconium compound having the formula of Zr(OR)₄, a zirconium chelate comprising or produced from Zr(OR)₄ and said complexing agent, or combinations thereof in which each R individually has 1 to about 30 carbon atoms per radical.

2. A composition according to claim 1 wherein said composition comprises, or is produced from, said stabilizer, optionally said solvent, said titanium or said titanium compound, and said complexing agent, which is ethanolamine, diethanolamine, triethanolamine, methyl, diethanolamine, dimethyl, ethanolamine, tri-isoproanolamine, or combinations of two or more thereof.

3. A composition according to claim 2 wherein said complexing agent is triethanolamine.

4. A composition according to claim 3 wherein said titanium compound is tetra isopropyl titanate, tetra n-butyl titanate, or combinations thereof.

5. A composition according to claim 1 wherein said stabilizer is said phosphorus-containing ester.

6. A composition according to claim 1 wherein said stabilizer is tris-phosphite ester, diphosphonite ester, or combinations thereof.

7. A composition according to claim 3 wherein said stabilizer is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-,tetrakis(2,4-bis(1,1-dimethylethyl)phenyl)ester; (tris-(2,4-di-t-butyl)phosphite; triethlyene glycol phosphite; tripropylene glycol phosphite; tributylene glycol phosphite; or combinations of two or more thereof.

8. A composition according to claim 4 wherein said stabilizer is triethyl phosphite; tributyl phosphite; tri-isopropylphosphite; or combinations of two or more thereof

9. A composition according to claim 1 wherein said stabilizer is said zirconium compound.

10. A composition according to claim 2 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

11. A composition according to claim 3 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

12. A composition according to claim 4 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof

13. A composition according to claim 8 further comprising tin or a tin compound.

14. A composition according to claim 12 further comprising tin or a tin compound.

15. A composition according to claim 1 wherein said composition comprises, or is produced from, said stabilizer, optionally said solvent, and said titanium chelate.

16. A composition according to claim 15 wherein said titanium chelate is produced from a tetraalkyl titanate and either ethanolamine, diethanolamine, triethanolamine, methyl, diethanolamine, dimethyl, ethanolamine, tri-isoproanolamine, or combinations of two or more thereof.

17. A composition according to claim 16 wherein said titanium compound is tetra isopropyl titanate, tetra n-butyl titanate, or combinations thereof.

18. A composition according to claim 16 wherein said titanium chelate is TYZOR® TE (bis(triethanolamino) titanate in isopropanol).

19. A composition according to claim 16 wherein said stabilizer is said phosphorus-containing ester, which is tris-phosphite ester, diphosphonite ester, or combinations thereof.

20. A composition according to claim 17 wherein said stabilizer is said phosphorus-containing ester, which is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-10,tetrakis(2,4-bis(1,1-dimethylethyl)phenyl)ester; (tris-(2,4-di-t-butyl)phosphite; triethlyene glycol phosphite; tripropylene glycol phosphite; tributylene glycol phosphite; or combinations of two or more thereof.

21. A composition according to claim 18 wherein said stabilizer is said phosphorus-containing ester, which is triethyl phosphite; tributyl phosphite; tri-isopropylphosphite; or combinations of two or more thereof

22. A composition according to claim 15 wherein said stabilizer is said zirconium compound.

23. A composition according to claim 17 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

24. A composition according to claim 18 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

25. A process comprising contacting, in the presence of a catalyst, a carbonyl compound with an alcohol wherein said catalyst comprises, or is produced from, titanium or a titanium compound, a complexing agent, a stabilizer, and optionally a solvent; said complexing agent is an alkanolamine; and said stabilizer is a phosphorus-containing ester containing no free P—OH group, a zirconium compound having the formula of Zr(OR)₄, a zirconium chelate comprising or produced from Zr(OR)₄ and said complexing agent, or combinations thereof; each R individually has 1 to about 30 carbon atoms per radical.

26. A process according to claim 25 wherein said complexing agent is an alkanolamine, which optionally contains one or more hydroxyalkyl groups.

27. A process according to claim 26 wherein said complexing agent is ethanolamine, diethanolamine, triethanolamine, methyl, diethanolamine, dimethyl, ethanolamine, tri-isoproanolamine, and combinations of two or more thereof.

28. A process according to claim 27 wherein said complexing agent is triethanolamine.

29. A process according to claim 28 wherein said titanium compound is tetra isopropyl titanate, tetra n-butyl titanate, or combinations thereof.

30. A process according to claim 25 wherein said stabilizer is said phosphorus-containing ester, which is tris-phosphite ester, diphosphonite ester, or combinations thereof.

31. A process according to claim 28 wherein said stabilizer is said phosphorus-containing ester, which is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-tetrakis(2,4-bis(1,1-dimethylethyl)phenyl)ester; (tris-(2,4-di-t-butyl)phosphite; triethlyene glycol phosphite; tripropylene glycol phosphite; tributylene glycol phosphite; or combinations of two or more thereof.

32. A process according to claim 29 wherein said stabilizer is said phosphorus-containing ester, which is triethyl phosphite; tributyl phosphite; tri-isopropylphosphite; or combinations of two or more thereof

33. A process according to claim 32 wherein said carbonyl compound is terephthalic acid, its ester, its salt, or combinations thereof and said alcohol is butylene glycol or ethylene glycol.

34. A process according to claim 25 wherein said stabilizer is said zirconium compound.

35. A process according to claim 27 wherein said stabilizer is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

36. A process according to claim 29 wherein said stabilizer is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

37. A process according to claim 36 wherein said carbonyl compound is terephthalic acid, its ester, its salt, or combinations thereof and said alcohol is butylene glycol or ethylene glycol.

38. A process comprising contacting, in the presence of a catalyst, a carbonyl compound with an alcohol to produce a product comprising an oligomer wherein said catalyst comprises, or is produced from, a titanium chelate, a color stabilizer, and optionally a solvent; said stabilizer is a phosphorus-containing ester containing no free P—OH group, a zirconium chelate comprising or produced from Zr(OR)₄ and a complexing agent in which each R individually has 1 to about 30 carbon atoms per radical; and said oligomer comprises repeat units derived from said carbonyl compound and said alcohol.

39. A process according to claim 38 wherein said titanium chelate is TYZOR® TE (bis(triethanolamino) titanate in isopropanol).

40. A process according to claim 38 wherein said stabilizer is said phosphorus-containing ester, which is tris-phosphite ester, diphosphonite ester, or combinations thereof.

41. A process according to claim 39 wherein said stabilizer is said phosphorus-containing ester, which is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-,tetrakis(2,4-bis(1,1-dimethylethyl)phenyl)ester; (tris-(2,4-di-t-butyl)phosphite; triethlyene glycol phosphite; tripropylene glycol phosphite; tributylene glycol phosphite; or combinations of two or more thereof.

42. A process according to claim 39 wherein said stabilizer is said phosphorus-containing ester, which is triethyl phosphite; tributyl phosphite; tri-isopropylphosphite; or combinations of two or more thereof

43. A process according to claim 42 wherein said carbonyl compound is terephthalic acid, its ester, its salt, or combinations thereof and said alcohol is butylene glycol or ethylene glycol.

44. A process according to claim 38 wherein said stabilizer is said zirconium compound.

45. A process according to claim 39 wherein said stabilizer is said zirconium compound, which is TYZOR® NPZ (tetrapropyl zirconate), TYZOR® NBZ (tetrabutyl zirconate), TYZOR® TEAZ (tetrakis(triethanolamino)zirconate), or combinations of two or more thereof.

46. A process according to claim 45 wherein said carbonyl compound is terephthalic acid, its ester, its salt, or combinations thereof and said alcohol is butylene glycol or ethylene glycol.
